(19) United States
(12) Patent Application Publication
(10) Pub. No.: US 2026/0189756 A1
(43) Pub. Date: Jul. 2, 2026

(54) METHOD OF VIDEO RESOURCE MANAGEMENT AND APPARATUS, ELECTRONIC DEVICE AND STORAGE MEDIUM

(71) Applicants: Beijing Zitiao Network Technology Co., Ltd., Beijing (CN); Lemon Inc., Grand Cayman (KY)

(72) Inventors: Weihui DENG, Beijing (CN); Shenglan HUANG, Culver City, CA (US); Xiaocheng LI, Beijing (CN); Bin WANG, Beijing (CN); Ti GONG, Beijing (CN); Heng LIU, Beijing (CN); Mingkui LIU, Culver City, CA (US); Yiting LIAO, Los Angeles, CA (US); Junlin LI, Los Angeles, CA (US)

(21) Appl. No.: 18/865,307

(22) PCT Filed: May 30, 2023
(86) PCT No.: PCT/CN2023/097056

§ 371 Date: Nov. 12, 2024

(30) Foreign Application Priority Data
Jul. 6, 2022 (CN) 202210796813.0

(51) Int. Cl. H04N 21/462; H04N 21/4402

(52) U.S. Cl. CPC H04N 21/462; H04N 21/440218

(57) ABSTRACT

The invention provides a method and an apparatus of video resource management, electronic device and a storage medium. The method of video resource management includes: determining service metric information of each candidate video profile of a target video, to obtain at least one candidate profile combination, wherein a candidate profile combination comprises at least one candidate video profile; for each candidate profile combination, determining target metric information of a candidate profile combination according to service metric information of each candidate video profile within a candidate profile combination; determining a target profile combination of a target video from at least one candidate profile combination according to target metric information of each candidate profile combination.

This application claims the benefit of Chinese Patent Application No. 202210796813.0, filed on Jul. 6, 2022, which is hereby incorporated by reference in its entirety.

### FIELD

The present disclosure relates to the field of video processing technologies, and in particular, to a method of video resource management and apparatus, an electronic device, and a storage medium.

### BACKGROUND

In the era of mobile Internet, video has become an indispensable part of people's lives.

In a process of watching a video on a video platform by a user, the video platform may automatically help a user select a currently played video profile from a video profile combination determined by a video manufacturer for the video in advance, so as to expect proper balance in image quality and performance.

In order to improve the video viewing experience of the user as a whole, the effective determination of the video profile combination is crucial. However, the determined video profile combination is poor and needs to be improved.

### SUMMARY

The invention provides a method of video resource management and apparatus, electronic device and a storage medium, and aims to obtain a video profile combination with better service metric.

According to a first aspect, the present disclosure provides a method of video resource management, which may include:
Determining service metric information of each candidate video profile of a target video, to obtain at least one candidate profile combination, wherein a candidate profile combination comprises at least one candidate video profile;
For each candidate profile combination, determining target metric information of a candidate profile combination according to service metric information of each candidate video profile within a candidate profile combination;
Determining a target profile combination of a target video from at least one candidate profile combination according to target metric information of each candidate profile combination.

In a second aspect, the present disclosure further provides an apparatus of video resource management, which may include:
A candidate profile combination obtaining module, configured to determine service metric information of each candidate video profile of a target video, to obtain at least one candidate profile combination, wherein a candidate profile combination comprises at least one candidate video profile;
A target metric information determination module, configured to, for each candidate profile combination, determine target metric information of a candidate profile combination according to service metric information of each candidate video profile within a candidate profile combination;
A target profile combination determination module, configured to determine a target profile combination of a target video from at least one candidate profile combination according to target metric information of each candidate profile combination.

In a third aspect, the present disclosure further provides an electronic device, which may include:
One or more processors;
A memory configured to store one or more programs;
When the one or more programs are executed by the one or more processors, the one or more processors implement the foregoing method of video resource management.

According to a fourth aspect, the present disclosure further provides a computer-readable storage medium having a computer program stored thereon, where the computer program, when executed by a processor, implements the method of video resource management.

According to a fifth aspect, the present disclosure further provides a computer program product, including a computer program that is carried on a non-transitory computer readable medium, where the computer program includes program code for performing the foregoing method of video resource management.

### BRIEF DESCRIPTION OF DRAWINGS

FIG. 1 is a flowchart of a method of video resource management according to an embodiment of the present disclosure;

FIG. 2 is a flowchart of another method of video resource management according to an embodiment of the present disclosure;

FIG. 3 is a flowchart of another method of video resource management according to an embodiment of the present disclosure;

FIG. 4 is a flowchart of another method of video resource management according to an embodiment of the present disclosure;

FIG. 5 is a schematic diagram of an example of a method of video resource management according to an embodiment of the present disclosure;

FIG. 6 is a structural block diagram of an apparatus of video resource management according to an embodiment of the present disclosure;

FIG. 7 is a schematic structural diagram of an electronic device according to an embodiment of the present disclosure.

### DETAILED DESCRIPTION

Embodiments of the present disclosure will be described below with reference to the accompanying drawings. While some embodiments of the present disclosure are shown in the drawings, it should be understood that the present disclosure may be implemented in a variety of forms and should not be construed as limited to the embodiments set forth herein. It should be understood that the drawings and embodiments of the present disclosure are for exemplary purposes only.

It should be understood that the steps described in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

The names of messages or information interaction between multiple devices in embodiments of the present disclosure are for illustrative purposes only and are not intended to limit the scope of such messages or information.

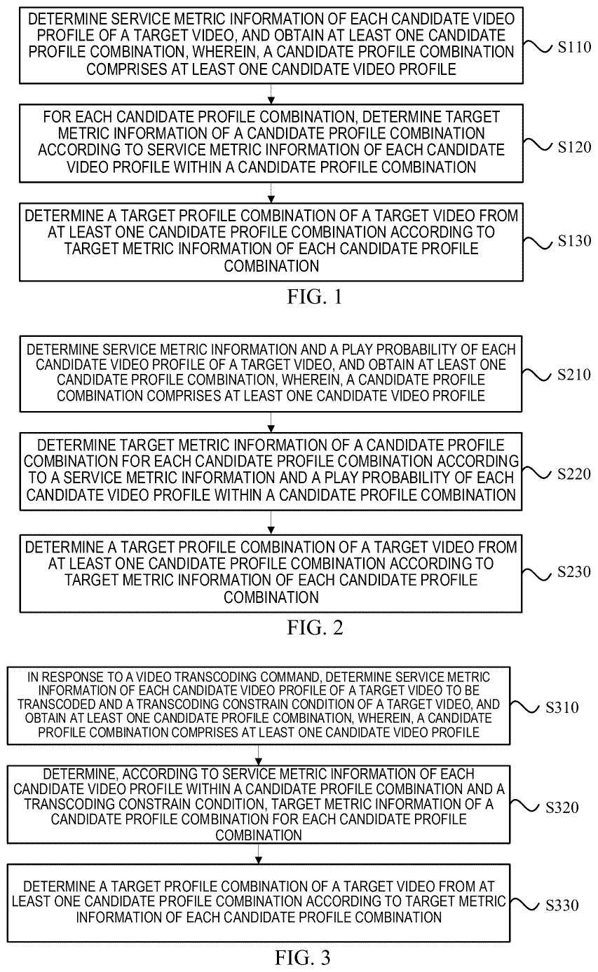

FIG. 1 is a flowchart of a method of video resource management according to an embodiment of the present disclosure. This embodiment may be applicable to a case in which a video profile combination is obtained and is particularly applicable to a case in which a better video profile combination is obtained in terms of service metrics. The method may be performed by an apparatus of video resource management provided in an embodiment of the present disclosure, the apparatus may be implemented by software and/or hardware, the apparatus may be integrated on an electronic device, and the electronic device may be a plurality of terminal devices or servers.

Referring to FIG. 1, a method according to an embodiment of the present disclosure includes the following steps:
S110: Determine service metric information of each candidate video profile of the target video, and obtain at least one candidate profile combination, where the candidate profile combination includes at least one candidate video profile.

A video profile may be understood as an encoded video obtained by a video manufacturer for a video based on a certain rule, one video may be encoded to obtain a plurality of video profiles, and the video profiles are from different encoder versions, and have different resolutions, code rates, or video qualities. The essence of the concepts such as the candidate video profiles, the prepared transcoding video profiles, the playing video profiles, the historical video profiles, and the transcoded video profiles mentioned in the following are video profiles, which are only used for distinguishing different naming of video profiles in different application scenarios, and are not intended to limit their essential meanings. The video profile combination may be a combination constructed based on at least one video profile, and similarly, the essence of concept concepts such as the candidate profile combination, the target profile combination, the prepared transcoding profile combination, the added transcoding profile combination and the final profile combination mentioned in the following is a video profile combination, which is only used for distinguishing different naming of video profile combinations in different application scenarios, and is not a limitation on their essential meanings.

The target video may be a video of a video profile combination (referred to herein as a target profile combination) whose own service metric is better. The candidate video profile may be a video profile available for encoding of the target video, in practical applications, the candidate video profile may be determined according to low-order information of the target video, the low-order information may be understood as content information of video content of the target video, and whether the target video is good or not may be determined according to the content information, so as to determine a candidate video profile of the target video. The candidate profile combination may be a video profile combination constructed based on at least one candidate video profile, for example, assuming that the target video corresponds to 3 candidate video profiles A, B, and C, the video profile combination may include the following 6 types: A, B, C, AB, BC, and ABC.

The service metric information may be understood as information of a candidate video profile in terms of a service metric, and the service metric may be a metric of a running status of a service such as a service value, a service profit, or a service cost; or may be a metric of a running status of a service, such as a user data metric, a behavior data metric, or a product data metric, which is not limited herein. When the service value is used as the service metric, the service value information may be reflected by the service information, the cost information, the external environment information, and the like. The remaining service metric information may also be represented by the several points, which is not limited herein. In practical applications, the service metric information may be represented in a plurality of manners such as a numerical value, a text, or an illustration, which is not limited herein.
S120: For each candidate profile combination, determining target metric information of the candidate profile combination according to the service metric information of each candidate video profile in the candidate profile combination.

For any candidate profile combination, the target metric information of the candidate profile combination is determined according to the service metric information of each candidate video profile in the candidate profile combination, for example, when the service metric information is represented by a numerical value, the weighted summation result of the service metric information may be used as the target metric information, and the weight coefficient may be determined according to the play probability, the transcoding overhead or the video quality of the corresponding candidate video profile; and when the service metric information is represented by the illustration, the processing result obtained after the illustration may be processed as the target metric information; and the like, which is not limited herein.
S130: Determine a target profile combination of the target video from the at least one candidate profile combination according to the target metric information of each candidate profile combination.

After the target metric information of some or all of the candidate profile combinations is obtained, the target profile combination of the target video may be obtained from the at least one candidate profile combination according to the target metric information of the candidate profile combinations. For example, when the target metric information is represented by a numerical value, the candidate profile combination corresponding to the maximum target metric information may be used as the target profile combination, and the target profile combination may be understood as the video profile combination with the maximum service metric; when the target metric information is represented by the illustration, the candidate profile combination corresponding to the target metric information with the minimum size may be used as the target profile combination, and the target profile combination may be understood as the video profile combination with the minimum service metric; and the like, which is not limited herein.

According to the technical scheme of the embodiment of the invention, the service metric information of each candidate video profile of the target video is determined, and the candidate profile combination constructed based on the at least one candidate video profile is obtained; for each candidate profile combination, the target metric information of the candidate profile combination is determined according to the service metric information of each candidate video profile in the candidate profile combination; and then, the target profile combination of the target video is determined from the at least one candidate profile combination according to the target metric information of each candidate profile combination. According to the technical scheme, the service metric information of each candidate video profile is combined into the determination process of the video profile combination of the target video, and the better video profile combination (namely, the target profile combination) in the aspect of the service metric is obtained.

In a technical solution, on the basis of the foregoing embodiment, determining the service metric information of each candidate video profile of the target video may include: obtaining a service metric function and profile attribute information of each candidate video profile of the target video, where the service metric function is constructed based on the profile attribute of the candidate video profile, and the profile attribute information is information of the candidate video profile in the profile attribute; for each candidate video profile, obtaining a service metric function value according to the service metric function and the profile attribute information of the candidate video profile, and using the service metric function value as the service metric information of the candidate video profile; correspondingly, determining the target profile combination of the target video from the at least one candidate profile combination according to the target metric information of each candidate profile combination may include: combining the candidate profile combinations corresponding to the target metric information with the largest numerical value in the target metric information of the at least one candidate profile combination as the target profile combination of the target video.

The service metric of the candidate video profile may be embodied by a service metric function, and the service metric information may be embodied by a function value (referred to herein as a service metric function value) of the service metric function. The service metric function may be pre-constructed based on the profile attributes of the candidate video profiles, for example, based on linear or non-linear combination of these profile attributes. In actual application, the profile attribute may include at least one of a video code rate, a video quality, a transcoding overhead, and a resolution (that is, a resolution of a transcoded video); the service metric functions of different candidate video profiles may be the same or different; each candidate video profile may correspond to one or more service metric functions, and when at least two service metric functions are correspondingly formed, a service metric function set is formed at this time. The profile attribute information may be information of a candidate video profile in a profile attribute, for example, a value of a video code rate or a value of a transcoding overhead.

For each candidate video profile, a service metric function value is obtained according to the service metric function and the profile attribute information of the candidate video profile, that is, the profile attribute information is brought into the service metric function to obtain a service metric function value, and the service metric function value is used as the service metric information. Further, because the service metric information is represented by a service metric function value, that is, a numerical manner, the target metric information obtained according to the service metric information may also be represented in a numerical manner, and therefore, the candidate profile combination corresponding to the target metric information with the largest numerical value in the at least one piece of target metric information may be used as the target profile combination, to obtain the video profile combination with the maximum service metric, and the foregoing processing process may be understood as a video profile combination optimization problem that is maximized based on the service metric.

FIG. 2 is a flowchart of another method of video resource management according to an embodiment of the present disclosure. This embodiment is described based on the solution in the foregoing embodiment. In this embodiment, the method of video resource management may further include: determining a playing probability of each candidate video profile; and determining the target metric information of the candidate profile combination according to the service metric information of each candidate video profile in the candidate profile combination may include: determining the target metric information of the candidate profile combination according to the service metric information and the playing probability of each candidate video profile in the candidate profile combination. For explanations of terms that are the same as or corresponding to the foregoing embodiments, details are not described herein again.

Correspondingly, as shown in FIG. 2, the method in this embodiment may include the following steps:
S210: Determine service metric information and a playing probability of each candidate video profile of the target video, and obtain at least one candidate profile combination, where the candidate profile combination includes at least one candidate video profile.

The playing probability of any candidate video profile may indicate the probability that the client selects the candidate video profile from the at least one candidate video profile delivered by the server, and the playing probabilities of different candidate video profiles may be the same or different, which is related to the actual situation, which is not limited herein.
S220: For each candidate profile combination, determining target metric information of the candidate profile combination according to the service metric information and the play probability of each candidate video profile in the candidate profile combination.

Due to the fact that the playing probabilities of different candidate video profiles in the candidate profile combination can be different, for any candidate video profile, only the candidate video profile is played, and the service metric of the candidate video profile can be reflected; therefore, in addition to the service metric information of the candidate video profile in the candidate profile combination, the playing probability of the candidate video profile can be referenced.

On this basis, the target metric information may be obtained through the following steps: taking each candidate video profile in the candidate profile combination as the playing video profile; for each playing video profile, obtaining the playing metric information of the playing video profile according to the service metric information and the playing probability of the playing video profile; and then, obtaining the target metric information of the candidate profile combination according to the playing metric information of each playing video profile. In other words, the playing probability of each playing video profile is first processed, the playing probability is better than that of the weighting coefficient, and then the playing metric information of the playing video profile obtained thereby is processed, so that the obtained target metric information can better reflect the service metric of the candidate profile combination.
S230: Determine a target profile combination of the target video from the at least one candidate profile combination according to the target metric information of each candidate profile combination.

According to the technical scheme of the embodiment of the invention, the playing probability of each candidate video profile is determined, so that when the target metric information is determined, the service metric information and the playing probability of each candidate video profile are considered at the same time, and the obtained target metric information can better represent the service metric of the candidate profile combination.

In a technical solution, on the basis of the foregoing embodiments, the determining a playing probability of each candidate video profile may include: obtaining a playing probability density function, where the playing probability distribution corresponding to the playing probability density function is obtained by fitting according to historical information of a video platform where the target video is located; for each candidate video profile, determining a playing probability of the candidate video profile based on the playing probability density function. The playing probability density function may be understood as a probability density function of playing probability distribution, and in practical applications, a playing probability distribution may be first fitting, so as to obtain a playing probability density function based on the playing probability distribution. Based on this, the playing probability distribution may be obtained by fitting according to historical information of a video platform where the target video is located, and then the obtained playing probability density function may be applicable to any playable video profile of any playable video played on the video platform. For each candidate video profile, the playing probability of the candidate video profile is determined based on the playing probability density function, and the playing probability of the ninth candidate video profile may be represented by the following formula:

$${p}_{i} = Pr ( Play ( R ) = {R}_{i} ) = {\int }_{{R}_{i}}^{{R}_{i + 1}} p ( R ) dR$$

where R represents a candidate video profile, P(R) represents a playing probability density function, and Rᵢ₊₁ represents the i+1^{th} candidate video profile, Play (R)=Rᵢ indicates that the candidate video profile Rᵢ is selected by the client for playing.

On this basis, the historical information includes at least one of user internet speed information, client playing profile information, and server sending profile information. The user internet speed information may be understood as internet speed information of all user on the video platform. The client playing profile information may be understood as the information about the historical video profile selected by the client from the at least one historical video profile delivered by the server, the historical video profile may be a video profile delivered by the server in the past for any historical video on the video platform, and the transmission profile information delivered by the server may be information of the historical video profile.

On this basis, when the historical information is user internet speed information, the playing probability distribution is obtained by fitting the following steps: determining a user internet speed distribution corresponding to the user internet speed information; for each network bandwidth under the user internet speed distribution, determining a maximum code rate corresponding to the network bandwidth, and determining a historical video profile corresponding to the maximum code rate; and fitting to obtain a playing probability distribution according to the user internet speed distribution and the historical video profile corresponding to each network bandwidth. In a relatively simple playing scenario, the playing probability distribution may be directly obtained according to the user internet speed distribution. Because there may be many user under each network bandwidth according to the user internet speed information, a corresponding user internet speed distribution may be obtained according to the user internet speed information. Further, for each network bandwidth under the user internet speed distribution, a maximum code rate corresponding to the network bandwidth may be determined, where the maximum code rate may be understood as a maximum video code rate of a historical video that can be smoothly played under the network bandwidth. For example, when the network bandwidth is band (R): in order to ensure the smooth playing of the historical video, the video code rates B(Rᵢ) of different historical video profiles of the historical video are all with B(Rᵢ)≤band (R), that is

$${}_{i = 1 … n}^{max} B ( {R}_{i} ) \leq band ( R ) , {}_{i = 1 , ⋯ , n}^{max} B ( {R}_{i} )$$

represents the maximum value of the video code rate of the historical video profile. On this basis, since the video code rate is one of the profile attributes of the historical video profile, it means that the historical video profile with the maximum code rate can be obtained, so that the play probability distribution can be obtained by fitting according to the user internet speed distribution and the historical video profile corresponding to each network bandwidth.

The playing probability distribution mentioned above is a probability distribution applicable to any playable video range of any playable video played on the video platform; in practical applications, it may also be a probability distribution applicable to all or part of the playable video profiles played on the video platform.

FIG. 3 is a flowchart of another method of video resource management according to an embodiment of the present disclosure. This embodiment is described based on the solution in the foregoing embodiment. In this embodiment, determining the service metric information of each candidate video profile of the target video may include: in response to the video transcoding command, determining service metric information of each candidate video profile of the target video to be transcoded and a transcoding constraint condition of the target video; and determining target metric information of the candidate profile combination according to the service metric information of each candidate video profile in the candidate profile combination, which may include: determining target metric information of the candidate profile combination according to the service metric information and the transcoding constraint condition of each candidate video profile in the candidate profile combination. For explanations of terms that are the same as or corresponding to the foregoing embodiments, details are not described herein again.

Correspondingly, as shown in FIG. 3, the method in this embodiment may include the following steps:
S310: Determine, in response to the video transcoding command, service metric information of each candidate video profile of the target video to be transcoded and a transcoding constraint condition of the target video, and obtain at least one candidate profile combination, where the candidate profile combination includes at least one candidate video profile.

The video transcoding command may be an instruction for transcoding (i.e., encoding) the target video to be transcoded; the transcoding constraint may be a constraint associated with the video transcoding command, which may include a condition on a number constraint of candidate video profiles, a condition on a difference constraint of video code rates of different candidate video profiles, or at least a condition on a profile constraint including one resolution, etc. In view of the application scenario that may be involved in the embodiments of the present disclosure, the above transcoding constraint condition may include at least one of the following conditions: a video code rate of each candidate video profile in the candidate profile combination is less than or equal to a preset maximum code rate and/or greater than or equal to a preset minimum code rate; a profile number of candidate video profiles in the candidate profile combination is less than or equal to a preset maximum quantity and/or greater than or equal to a preset minimum quantity; and a difference between video code rates of any two candidate video profiles in the candidate profile combination is less than or equal to a preset maximum code rate difference.
S320: for each candidate profile combination, determining target metric information of the candidate profile combination according to the service metric information of each candidate video profile in the candidate profile combination and the transcoding constraint condition.

When the target metric information is determined, in addition to the service metric information of the reference candidate video profile, reference may be made to the transcoding constraint condition, thereby ensuring that the obtained target metric information meets related requirements of the video transcoding command.
S330: Determine a target profile combination of the target video from the at least one candidate profile combination according to the target metric information of each candidate profile combination.

According to the technical scheme of the embodiment of the invention, when the target metric information is determined, the transcoding constraint condition determined for the video transcoding command of the target video can be referenced, so that the subsequent obtained target metric information meets the related requirements of the video transcoding command.

In a technical solution, based on the above embodiment, determining the target metric information of the candidate profile combination according to the service metric information of each candidate video profile in the candidate profile combination and the transcoding constraint condition may include: if the candidate profile combination meets the transcoding constraint condition, determining the target metric information of the candidate profile combination according to the service metric information of each candidate video profile in the candidate profile combination. In actual application, considering that some candidate profile combinations meet a transcoding constraint condition, some candidate profile combinations do not meet a transcoding constraint condition, and for a candidate profile combination satisfying a transcoding constraint condition, it means that the candidate profile combination is likely to be applied as a target profile combination, so that the target metric information of the candidate profile combination can be determined according to the service metric information of the candidate video profile in the candidate profile combination, thereby ensuring the accuracy of determining the target metric information; on this basis, for the candidate profile combination that does not meet the transcoding constraint condition, it means that the candidate profile combination does not serve as the target profile combination, then it is unnecessary to calculate the target metric information (that is, the target metric information is null), or the default metric information is directly used as the target metric information, thereby improving the determination speed of the target metric information.

To understand the effect of the transcoding constraint, for example, assuming that the transcoding constraint includes that the number of the candidate video profiles in the candidate profile combination is greater than or equal to 2, the candidate profile combination includes the following 6 types: A, B, C, AB, BC, and ABC, then the candidate profile combination satisfying the transcoding constraint includes the following 3: AB, BC and ABC.

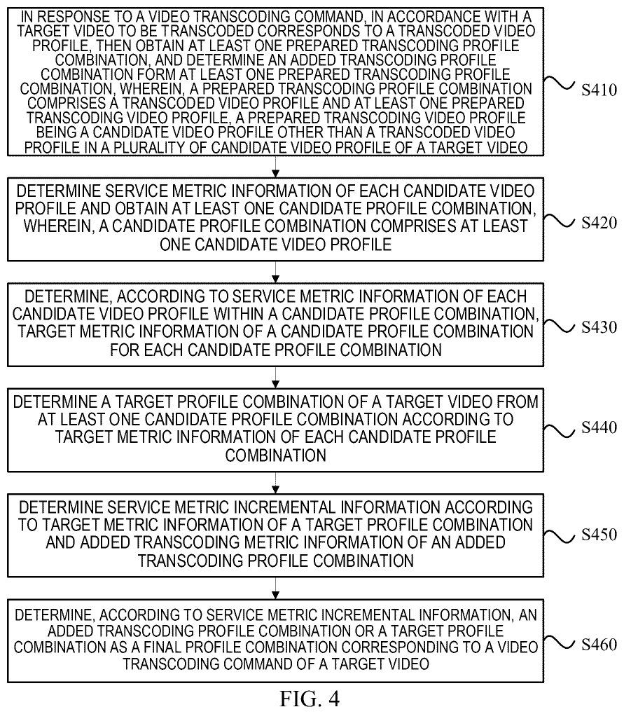

FIG. 4 is a flowchart of another method of video resource management according to an embodiment of the present disclosure. This embodiment is described based on the solution in the foregoing embodiment. In this embodiment, the foregoing method of video resource management may further include: in response to a video transcoding command, if a target video to be transcoded corresponds to a transcoded video profile, obtaining at least one prepared transcoding profile combination, where the prepared transcoding profile combination may include a transcoded video profile and at least one prepared transcoding video profile, and the prepared transcoding video profile is a candidate video profile other than the transcoded video profile among the plurality of candidate video profiles; determining an added transcoding profile combination from the at least one prepared transcoding profile combination; determining service metric incremental information according to the target metric information of the target profile combination and the rotation metric information of the added transcoding profile combination; and determining to combine the added transcoding profile combination or the target profile combination as a final profile combination corresponding to the video transcoding command of the target video according to the service metric incremental information. Explanations of the same or corresponding terms as those in the foregoing embodiments are not described herein again.

Correspondingly, as shown in FIG. 4, the method in this embodiment may include the following steps:
S410: in response to the video transcoding command, if the target video to be transcoded corresponds to a transcoded video profile, obtaining at least one prepared transcoding profile combination, and determining an added transcoding profile combination from the at least one prepared transcoding profile combination, wherein the prepared transcoding profile combination includes a transcoded video profile and at least one prepared transcoding video profile, and the prepared transcoding video profile is a candidate video profile other than the transcoded video profile among the plurality of candidate video profiles of the target video.

The transcoded video profile may be a video profile obtained by transcoding the target video before the video transcoding command is received, and if the target video corresponds to a transcoded video profile, this indicates that the transcoding scenario is an add-in scene, that is, on the basis of the transcoded video profile, a new video profile scene is replayed. For example, when a video is just released, the popularity of the video is limited, and then only 2 video profiles (that is, the transcoded video profile) may be transferred; over time, the popularity of the video is continuously increased, and the video may be added, that is, a added transcoding scenario.

The prepared transcoding profile combination may include a transcoded video profile that is a candidate video profile of the plurality of candidate video profiles other than the transcoded video profile and at least one prepared transcoding video profile. On this basis, the added transcoding profile combination may be determined from the at least one prepared transcoding profile combination, and this determination process is similar to the process of determining the target profile combination from the at least one candidate profile combination, for example, determining the service metric information of the transcoded video profile and the service metric information of each prepared transcoding video profile, so as to determine the acceleration metric information of each prepared transcoding profile combination according to the service metric information, and then determining the added transcoding profile combination from the at least one prepared transcoding profile combination according to the added transcoding metric information, and this determination process is set forth above, and details are not described herein again.
S420: Determine service metric information of each candidate video profile, and obtain at least one candidate profile combination, where the candidate profile combination includes at least one candidate video profile.
S430: For each candidate profile combination, determining target metric information of the candidate profile combination according to the service metric information of each candidate video profile in the candidate profile combination.
S440: Determine a target profile combination of the target video from the at least one candidate profile combination according to the target metric information of each candidate profile combination.
S450: Determining the service metric incremental information according to the target metric information of the target profile combination and the added transcoding metric information of the added transcoding profile combination.

In the added transcoding scenario, it may be determined, by using the service metric increment, which of the added transcoding profile combination and the target profile combination is the final profile combination corresponding to the video transcoding command of the target video, and the service metric increment may be understood as an increment of the service metric brought by one video profile combination relative to the service metric brought by another video profile combination. In practical applications, the service metric increment may be represented by the service metric incremental information, and the service metric incremental information may be determined according to the target metric information of the target profile combination and the added transcoding information of the added transcoding profile combination.
S460: Determine, based on the service metric incremental information, a added transcoding profile combination or a target profile combination as a final profile combination corresponding to the video transcoding command of the target video.

Because the service metric incremental information may indicate which video profile combination results in a larger service metric and a large amount, it may be determined according to the service metric incremental information whether to combine the added transcoding profile combination or the target profile combination as the final profile combination.

According to the technical scheme of the embodiment of the invention, in the added transcoding scene, the service metric incremental information is determined through the target metric information of the target profile combination and the rotation metric information of the rotation profile combination, and since the service metric incremental information can indicate which of the target profile combination and the added transcoding profile combination brings a larger service metric and is large, the addition of the added transcoding profile combination or the target profile combination as the final profile combination can be determined according to the service metric incremental information, so that the accurate determination of the video profile combination (namely the final profile combination) in the added transcoding scene is realized.

According to the technical scheme, on the basis of the above embodiment, the target metric information of the target profile combination is represented by a target metric function value, and the rotation metric information of the addition profile combination is represented by an added transcoding metric function value, and the determining the service metric incremental information according to the target metric information of the target profile combination and the rotation metric information of the addition profile combination can comprise: taking the difference value between the target metric function value and the added transcoding metric function value as the service metric incremental information; according to the service metric incremental information, determining to combine the added transcoding profile combination or the target profile combination as the final profile combination corresponding to the video transcoding command of the target video; if the service metric incremental information is greater than the preset increment threshold, taking the target profile combination as the final profile combination corresponding to the video transcoding command of the target video; and if the service metric incremental information is not greater than the preset increment threshold, combining the added transcoding profile combination as the final profile combination. Generally, when the target metric function value is greater than or equal to the added transcoding metric function value, the service metric incremental information may be represented based on a difference between the target metric function value and the added transcoding metric function value. On this basis, when the service metric incremental information is greater than the preset increment threshold, it indicates that the service metric brought by the target profile combination is much greater than the service metric brought by the added transcoding profile combination, and the target profile combination may be used as the final profile combination; when the service metric incremental information is not greater than the preset increment threshold, it indicates that the service metric brought by the target profile combination is not much greater than the service metric brought by the added transcoding profile combination, and the previously obtained transcoded video profile has paid a certain transcoding overhead, then the added transcoding profile combination may be used as the final profile combination, and at this time, the previous transcoded video profile may be repeatedly used. According to the technical scheme, the final profile combination which can balance the service metric and the transcoding overhead is obtained.

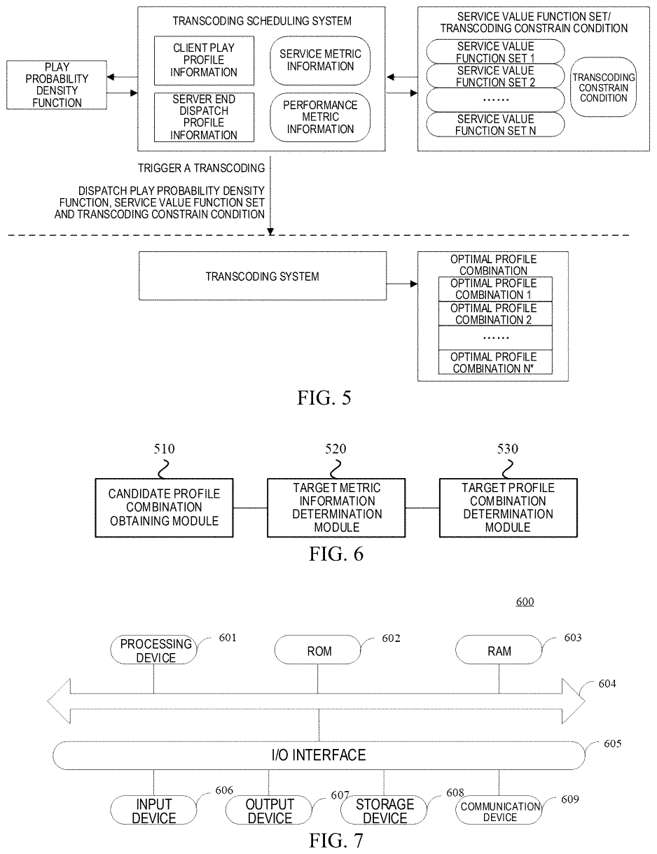

In order to understand the above technical solution as a whole, the following is exemplarily described with reference to the examples. With reference to the application scenario that may be involved in the embodiments of the present disclosure, the service metric is represented next based on the service value. Exemplarily, the final target of the video profile combination optimization problem may be that the service value is maximized, in order to achieve this goal, the service value information is fused into the video coding selection process, the framework is as shown in FIG. 5, the entire framework is divided into a transcoding scheduling system and a transcoding system, the transcoding scheduling system is responsible for triggering scheduling of video transcoding, service value judgment and playing probability density function calculation, etc., the transcoding system is mainly responsible for low-order information analysis of the target video to be transcoded, a playing probability density function P (x) transparently transmitted based on the transcoding scheduling system, a value function set, and a transcoding constraint optimal profile combination calculation, and video transcoding is performed. The steps are as follows:
Step 1: The transcoding scheduling system determines whether to trigger transcoding according to the playing information of each video, and uses the video that needs to be transcoded as the target video to be transcoded.
Step 2: Before submitting the transcoding task of the target video to the transcoding system, the transcoding scheduling system firstly obtains a corresponding playing probability density function p (x), a service value function set (Func) and a transcoding constraint (Rule) based on the video information of the target video, and transparently transmits the three to the transcoding system. The service metric information and the performance metric information in the figure may include at least one of a video code rate, a video quality, a transcoding overhead, and a resolution.
Step 3: The transcoding system firstly analyzes the low-order information of the target video itself to obtain a candidate video profile set of the target video, wherein the candidate video profile set comprises n candidate video profiles, and n is a positive integer, thereby constructing at least one candidate profile combination; and then calculating the target profile combination of the current transcoding according to p (x), Func and Rule transparently transmitted by the transcoding scheduling system. The calculation process of the target profile combination may be understood as an optimization problem of maximizing the service value, and the optimization problem may be formalized as the following formula:

$$Q ( {R}_{1}^{*} , ⋯ , {R}_{{n}^{*}}^{*} ) = {}_{{R}_{1} , ⋯ , {R}_{n}}^{max} Q ( p , {R}_{1} , ⋯ , {R}_{n} )$$

where Q represents a target function of the optimization problem, R₁, . . . , Rₙ represents a candidate video profile in any candidate profile combination, and the right representation of the formula sequentially calculates Q of each candidate profile combination to obtain a target function value of each candidate profile combination, so that the candidate profile combination corresponding to the maximum target function value is used as the target profile combination (i.e., the left side),

$${R}_{1}^{*} , ⋯ , {R}_{{n}^{*}}^{*}$$

represents the candidate video profile in the target profile combination. The transcoding constraint that needs to be met by the optimization problem is as follows:

$${B}_{min} \leq B ( {R}_{1} ) \leq ⋯ \leq B ( {R}_{n} ) \leq {B}_{max}$$

$${N}_{min} \leq {n}^{*} \leq {N}_{max}$$

$$∀ i , j , B ( {R}_{i} ) - B ( {R}_{j} ) \leq {B}_{gap}$$

where Bₘᵢₙ represents a preset minimum code rate, Bₘₐₓ represents a preset maximum code rate, Nₘᵢₙ represents a preset minimum quantity, Nₘₐₓ represents a preset maximum quantity, B(Rᵢ) represents a video code rate of Rᵢ, B(Rⱼ) represents a video code rate of Rⱼ, B_{gap} represents a preset maximum code rate difference, and these concepts have been described in the foregoing, and details are not described herein again.

The objective function Q may be expressed as:

$$( p , {R}_{1} , ⋯ , {R}_{n} ) = {\sum }_{i = 1}^{n} ( {p}_{i} * {f}_{i} ( B ( {R}_{i} ) , V ( {R}_{i} ) , C ( {R}_{i} ) , Res ( {R}_{i} ) ) )$$

where pᵢ represents a playing probability of Rᵢ, fᵢ is a corresponding service value function corresponding to Rᵢ, V(Rᵢ) represents a video quality of Rᵢ, C(Rᵢ) represents a transcoding overhead of Rᵢ, and Res(Rᵢ) represents a resolution of Rᵢ, and these concepts have been introduced in the foregoing description, and details are not described herein again.

On this basis, fᵢ(B(Rᵢ), V(Rᵢ), C(Rᵢ), Res(Rᵢ)) may be represented by the following formula:

$${f}_{i} = {k}_{1} * B ′ ( {R}_{i} ) + {k}_{2} * V ′ ( {R}_{i} ) + {k}_{2} * C ′ ( {R}_{i} ) + {k}_{4} * Res ′ ( {R}_{i} ) + {k}_{5}$$

Where B·(Rᵢ), V·(Rᵢ), C·(Rᵢ) and Res·(Rᵢ) are the values after the dimensionalization on B(Rᵢ), V(Rᵢ), C(Rᵢ) and Res(Rᵢ), k₁, k₂, k₂ and k₄ are the corresponding weight coefficient, k₅ represents other valuable business information fusion.
Step 4. Determine whether the transcoding scenario is an add-in scenario. If the transcoding scenario is not the added transcoding scenario, the target profile combination obtained in step 3 is still taken as the optimal profile combination, and if the transcoding scenario is the judgment of the service value increment in the added transcoding scenario, the process is as follows: assuming that the transcoded video profile is a sum, the optimization problem at this time is represented by the following formula, where m=n−2:

$${Q}_{add} ( {L}_{1} , {L}_{2} , {R}_{1}^{*} , ⋯ , {R}_{{m}^{*}}^{*} ) = {}_{{R}_{1} , ⋯ , {R}_{m}}^{max} {Q}_{add} ( p , {L}_{1} , {L}_{2} , {R}_{1} , ⋯ , {R}_{m} )$$

The corresponding transcoding constraints are as follows:

$${B}_{min} \leq B ( {R}_{i} ) \leq {B}_{max} , {R}_{i} ∈ \{ {L}_{1} , {L}_{2} , {L}_{1} , ⋯ , {R}_{m} \}$$

$${N}_{min} - 2 \leq {m}^{*} \leq {N}_{max} - 2$$

$$∀ i , j , B ( {R}_{i} ) - B ( {R}_{j} ) \leq {B}_{gap} and {R}_{i} , {R}_{j} ∈ \{ {L}_{1} , {L}_{2} , {R}_{1} , ⋯ , {R}_{m} \}$$

In general,

$${Q}_{add} ( {L}_{1} , {L}_{2} , {R}_{1}^{*} , ⋯ , {R}_{{m}^{*}}^{*} ) \leq Q ( {R}_{1}^{*} , ⋯ , {R}_{{n}^{*}}^{*} )$$

The service value increment is represented by the following formula:

$$Δ Q = Q ( {R}_{1}^{*} , ⋯ , {R}_{{n}^{*}}^{*} ) - {Q}_{add} ( {L}_{1} , {L}_{2} , {R}_{1}^{*} , ⋯ , {R}_{{m}^{*}}^{*} )$$

If ΔQ is greater than the preset increment threshold δ, use

$${R}_{1}^{*} , ⋯ , {R}_{{n}^{*}}^{*}$$

obtained in step 3 as the optimal profile combination, and ΔQ is not greater than the preset increment threshold δ, use L₁, L₂,

$${R}_{1}^{*} , ⋯ , {R}_{{m}^{*}}^{*}$$

obtained in step 4 as the optimal profile combination. Since L₁, L₂ exist and only

$${R}_{1}^{*} , ⋯ , {R}_{{m}^{*}}^{*}$$

need to be output
Step 5: Perform transcoding based on the optimal profile combination obtained in step 3 or step 4, and then calls back the corresponding information to the transcoding scheduling system.

FIG. 6 is a structural block diagram of an apparatus of video resource management according to an embodiment of the present disclosure. The apparatus and the method of video resource management in the foregoing embodiments belong to a same concept, and details content not described in detail in the embodiments of the apparatus of video resource management may refer to an embodiment of the foregoing method of video resource management. Referring to FIG. 6, the apparatus may include: a candidate profile combination obtaining module 510, a target metric information determination module 520, and a target profile combination determination module 530. The candidate profile combination obtaining module 510 is configured to determine service metric information of each candidate video profile of the target video and obtain at least one candidate profile combination, wherein the candidate profile combination comprises at least one candidate video profile; the target metric information determination module 520 is configured to, for each candidate profile combination, determine target metric information of the candidate profile combination according to the service metric information of each candidate video profile in the candidate profile combination; and the target profile combination determination module 530 is configured to determine a target profile combination of the target video from the at least one candidate profile combination according to the target metric information of each candidate profile combination.

The candidate profile combination obtaining module 510 may include: a profile attribute information obtaining unit, configured to obtain a service metric function and profile attribute information of each candidate video profile of the target video, where the service metric function is constructed based on the profile attribute of the candidate video profile, and the profile attribute information is information of the candidate video profile in the profile attribute; a first obtaining unit, configured to obtain, for each candidate video profile, a service metric function value according to the service metric function and the profile attribute information of the candidate video profile, and use the service metric function value as the service metric information of the candidate video profile; and the target profile combination determination module 530, may be configured to combine, as the target profile combination of the target video, the candidate profile combination corresponding to the target metric information with the largest value in the target metric information of the at least one candidate profile combination.

On this basis, the profile attribute may include at least one of a video code rate, a video quality, a transcoding overhead, and a resolution.

The apparatus of video resource management may further include: a playing probability determination module, configured to determine a playing probability of each candidate video profile; and a target metric information determination module 520, which may include: a first determination unit, configured to determine target metric information of the candidate profile combination according to the service metric information and the playing probability of each candidate video profile in the candidate profile combination.

On this basis, the first determination unit of the target metric information may include: a playing video profile obtaining subunit, configured to use each candidate video profile in the candidate profile combination as a playing video profile; a playing metric information obtaining subunit, configured to, for each playing video profile, obtain playing metric information of the playing video profile according to the service metric information and the playing probability of the playing video profile; and a target metric information obtaining subunit, configured to obtain target metric information of the candidate profile combination according to the playing metric information of each playing video profile.

The playing probability determination module may include: a playing probability density function obtaining unit, configured to obtain a playing probability density function, where a playing probability distribution corresponding to the playing probability density function is obtained by fitting according to historical information of a video platform where the target video is located; and a playing probability determination unit, configured to determine, for each candidate video profile, a playing probability of the candidate video profile based on the playing probability density function.

On this basis, the historical information includes at least one of user internet speed information, client playing profile information, and server sending profile information.

On this basis, when the historical information is user internet speed information, the playing probability distribution is obtained through the following units: a user internet speed distribution determination unit, configured to determine a user internet speed distribution corresponding to the user internet speed information; a historical video profile determination unit, configured to determine, for each network bandwidth under the user internet speed distribution, a maximum code rate corresponding to the network bandwidth, and determine a historical video profile corresponding to the maximum code rate; and a playing probability distribution fitting unit, configured to fitting the playing probability distribution according to the user internet speed distribution and the historical video profile corresponding to each network bandwidth.

The profile combination selection obtaining module 510 may include: a service metric information second obtaining unit, configured to determine, in response to the video transcoding command, a transcoding constraint condition of the target video to be transcoded and service metric information of each candidate video profile of the target video; and the target metric information determination module 520 may include: a second determination unit, configured to determine, according to the service metric information of each candidate video profile in the candidate profile combination and the transcoding constraint condition, the target metric information of the candidate profile combination.

On this basis, the target metric information second determination unit may be configured to: if the candidate profile combination meets the transcoding constraint condition, determine the target metric information of the candidate profile combination according to the service metric information of each candidate video profile in the candidate profile combination.

The transcoding constraint condition includes at least one of the following conditions: a video code rate of each candidate video profile in the candidate profile combination is less than or equal to a preset maximum code rate and/or greater than or equal to a preset minimum code rate; a profile number of candidate video profiles in the candidate profile combination is less than or equal to a preset maximum quantity and/or greater than or equal to a preset minimum quantity; and a difference between video code rates of any two candidate video profiles in the candidate profile combination is less than or equal to a preset maximum code rate difference.

The video resource management device may further include: a prepared transcoding profile combination obtaining module, configured to, in response to the video transcoding command, if the target video to be transcoded corresponds to a transcoded video profile, obtain at least one prepared transcoding profile combination, where the prepared transcoding profile combination may include a transcoded video profile and at least one prepared transcoding video profile, and the prepared transcoding video profile is a candidate video profile other than the transcoded video profile among the plurality of candidate video profiles; an addition profile combination determination module, configured to determine an addition profile combination from the at least one prepared transcoding profile combination; a service metric incremental information determination module, configured to determine service metric incremental information according to the target metric information of the target profile combination and the rotation metric information of the addition profile combination; and a final profile combination determination module, configured to determine, according to the service metric incremental information, to combine the added transcoding profile combination or the target profile combination as a final profile combination corresponding to the video transcoding command of the target video.

On this basis, the target metric information of the target profile combination is represented by the target metric function value, and the addition metric information of the addition profile combination is represented by the added transcoding metric function value; the service metric incremental information determination module may be configured to: take the difference between the target metric function value and the added transcoding metric function value as the service metric incremental information; the final profile combination determination module may include: a final profile combination first determination unit configured to, if the service metric incremental information is greater than the preset increment threshold, use the target profile combination as the final profile combination corresponding to the video transcoding command of the target video; and a final profile combination second determination unit configured to, if the service metric incremental information is not greater than the preset increment threshold, use the added transcoding profile combination as the final profile combination.

According to the video resource management device provided by the embodiment of the invention, the service metric information of each candidate video profile of the target video is determined through the candidate profile combination obtaining module, and the candidate profile combination constructed based on the at least one candidate video profile is obtained; for each candidate profile combination, the target metric information determination module determines the target metric information of the candidate profile combination according to the service metric information of each candidate video profile in the candidate profile combination; furthermore, the target profile combination determination module determines the target profile combination of the target video from the at least one candidate profile combination according to the target metric information of each candidate profile combination. According to the device, the service metric information of each candidate video profile can be combined with the video profile combination determination process of the target video, and the video profile combination with better service metric (namely, the target profile combination) is obtained.

The apparatus of video resource management provided in the embodiments of the present disclosure may perform the method of video resource management provided by any embodiment of the present disclosure, and has corresponding function modules and effects of the execution method.

In the foregoing embodiments of the apparatus of video resource management, the included units and modules are only divided according to function logic, but are not limited to the foregoing division, as long as a corresponding function can be implemented; in addition, names of the plurality of function units are merely used to facilitate mutual differentiation, and are not intended to limit the protection scope of the present disclosure.

FIG. 7 is a schematic structural diagram of an electronic device (such as the terminal device or server in FIG. 7) suitable for implementing the embodiments of the present disclosure. The electronic device 600 in the embodiments of the present disclosure may include a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital television (TV), a desktop computer, or the like. The electronic device 600 shown in FIG. 7 is merely an example, and should not impose any limitation on the functions and scope of use of the embodiments of the present disclosure.

As shown in FIG. 7, the electronic device 600 may include a processing device (for example, a central processing unit, a graphics processor, etc.) 601, which may perform various appropriate actions and processing according to a program stored in a read-only memory (ROM) 602 or a program loaded into a random access memory (RAM) 603 from a storage device 608. In the RAM 603, various programs and data required by the operation of the electronic device 600 are also stored. The processing device 601, the ROM 602, and the RAM 603 are connected to each other through a bus 604. An input/output (I/O) interface 605 is also connected to the bus 604.

Generally, the following devices may be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a speaker, a vibrator, etc.; a storage device 608 including, for example, a magnetic tape, a hard disk, etc.; and a communication device 609. The communication device 609 may allow the electronic device 600 to communicate wirelessly or wired with other devices to exchange data. Although an electronic device 600 having multiple devices is shown in FIG. 7, it is not required to implement or have all the devices shown. More or fewer devices may alternatively be implemented or provided.

According to an embodiment of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 609, or installed from the storage device 608, or from the ROM 602. When the computer program is executed by the processing apparatus 601, the foregoing functions defined in the method of the embodiments of the present disclosure are performed.

The computer readable medium described above may be a computer readable signal medium or a computer readable storage medium or any combination of the two. The computer-readable storage medium may be, for example, an electrical, magnetic, optical, electromagnetic, infrared, or semiconductor system, device, or device, or any combination thereof. Examples of the computer-readable storage medium may include: an electrical connection having one or more wires, a portable computer diskette, a hard disk, a RAM, a ROM, an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms, including electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including wires, optical cables, Radio Frequency (RF), and the like, or any suitable combination thereof.

In some implementations, the client, server may communicate using any currently known or future developed network protocol, such as Hypertext Transfer Protocol (HTTP), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs, and when the one or more programs are executed by the electronic device, the electronic device is caused to: determine service metric information of each candidate video profile of the target video, and obtain at least one candidate profile combination, wherein the candidate profile combination comprises at least one candidate video profile; for each candidate profile combination, determine target metric information of the candidate profile combination according to the service metric information of each candidate video profile in the candidate profile combination; and determine a target profile combination of the target video from the at least one candidate profile combination according to the target metric information of each candidate profile combination.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a LAN or WAN, or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the candidate profile combination obtaining module may be further described as “determining service metric information of each candidate video profile of the target video, and obtaining at least one candidate profile combination, where the candidate profile combination includes at least one candidate video profile module”.

The functions described above may be performed, at least in part, by one or more hardware logic components. For example, without limitation, the exemplary types of hardware logic components that may be used include: a field programmable gate array (FPGA), an application specific integrated circuit (ASIC), an application specific standard (ASSP), a system on chip (SOC), a complex programming logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, devices, or devices, or any suitable combination of the foregoing. Examples of machine-readable storage media may include electrical connections based on one or more lines, portable computer diskettes, hard disks, RAMS, ROMs, EPROMs or flash memories, optical fibers, CD-ROMs, optical storage devices, magnetic storage devices, or any suitable combination of the foregoing.

According to one or more embodiments of the present disclosure, a method of video resource management is provided [Example 1]. The method comprises:
Determining service metric information of each candidate video profile of the target video, and obtaining at least one candidate profile combination, where the candidate profile combination includes at least one candidate video profile;
For each candidate profile combination, determining target metric information of the candidate profile combination according to the service metric information of each candidate video profile in the candidate profile combination;
The target profile combination of the target video is determined from the at least one candidate profile combination according to the target metric information of each candidate profile combination.

According to one or more embodiments of the present disclosure, [Example 2] provided an example method of [Example 1] for determining service metric information of each candidate video profile of a target video, respectively, which may include:
Obtaining a service metric function and profile attribute information of each candidate video profile of the target video, where the service metric function is constructed based on the profile attribute of the candidate video profile, and the profile attribute information is information of the candidate video profile in the profile attribute;
For each candidate video profile, obtaining a service metric function value according to the service metric function and the profile attribute information of the candidate video profile, and using the service metric function value as the service metric information of the candidate video profile;
The determining the target profile combination of the target video from the at least one candidate profile combination according to the target metric information of each candidate profile combination may include:

The candidate profile combination corresponding to the target metric information with the largest numerical value in the target metric information of the at least one candidate profile combination is used as the target profile combination of the target video.

According to one or more embodiments of the present disclosure, [Example 3] provides the method of [Example 2], the profile attributes including at least one of video code rate, video quality, transcoding overhead, and resolution.

According to one or more embodiments of the present disclosure, [Example 4] provides the method of [Example 4], the method of video resource management may further include:
Determining a playing probability of each candidate video profile;
The determining the target metric information of the candidate profile combination according to the service metric information of each candidate video profile in the candidate profile combination may include:

The target metric information of the candidate profile combination is determined according to the service metric information and the playing probability of each candidate video profile in the candidate profile combination.

According to one or more embodiments of the present disclosure, [Example 5] provides the method of [Example 4], the method for determining the target metric information of the candidate profile combination according to the service metric information and the play probability of each candidate video profile in the candidate profile combination may include:
Taking each candidate video profile in the candidate profile combination as a playing video profile;
For each playing video profile, obtaining playing metric information of the playing video profile according to the service metric information and the playing probability of the playing video profile;
Obtaining target metric information of the candidate profile combination according to the playing metric information of each playing video profile.

According to one or more embodiments of the present disclosure, [Example 6] provides the method of [Example 4], and determining the playing probability of each candidate video profile may include:
Obtaining a playing probability density function, wherein the playing probability distribution corresponding to the playing probability density function is obtained by fitting according to historical information of a video platform where the target video is located;
For each candidate video profile, a playing probability of the candidate video profile is determined based on the playing probability density function.

According to one or more embodiments of the present disclosure, [Example 7] provides the method of [Example 7], the historical information includes at least one of user internet speed information, client playing profile information, and server issuing profile information.

According to one or more embodiments of the present disclosure, [Example 8] provides the method of [Example 7], when the historical information is user internet speed information, the playing probability distribution is obtained by fitting the following operations:
Determining a user internet speed distribution corresponding to user internet speed information;
For each network bandwidth under the user internet speed distribution, determining a maximum code rate corresponding to the network bandwidth, and determining a historical video profile corresponding to the maximum code rate;
The playing probability distribution is obtained by fitting according to the user internet speed distribution and the historical video profile corresponding to each network bandwidth.

According to one or more embodiments of the present disclosure, [Example 9] provides the method of [Example 1], the determining service metric information of each candidate video profile of the target video according to example one of the present disclosure may include:
In response to the video transcoding command, determining a transcoding constraint condition of the target video to be transcoded and service metric information of each candidate video profile of the target video;
The determining the target metric information of the candidate profile combination according to the service metric information of each candidate video profile in the candidate profile combination may include:

The target metric information of the candidate profile combination is determined according to the service metric information of each candidate video profile in the candidate profile combination and the transcoding constraint condition.

According to one or more embodiments of the present disclosure, [Example 9] provides the method of [Example 1], the determining the target metric information of the candidate profile combination according to the service metric information of each candidate video profile in the candidate profile combination and the transcoding constraint condition may include:

If the candidate profile combination meets the transcoding constraint condition, the target metric information of the candidate profile combination is determined according to the service metric information of each candidate video profile in the candidate profile combination.

According to one or more embodiments of the present disclosure, [Example 11] provides the method of [Example 9], the transcoding constraint includes at least one of the following conditions:
A video code rate of each candidate video profile in the candidate profile combination is less than or equal to a preset maximum code rate and/or greater than or equal to a preset minimum code rate;
The number of the candidate video profiles in the candidate profile combination is less than or equal to the preset maximum number and/or greater than or equal to the preset minimum number;
A difference between the video code rates of any two candidate video profiles in the candidate profile combination is less than or equal to a preset maximum code rate difference.

According to one or more embodiments of the present disclosure, [Example 12] provides the method of [Example 1], the above method of video resource management may further include:
In response to the video transcoding command, if the target video to be transcoded corresponds to a transcoded video profile, obtaining at least one prepared transcoding profile combination, where the prepared transcoding profile combination may include a transcoded video profile and at least one prepared transcoding video profile, and the prepared transcoding video profile is a candidate video profile other than the transcoded video profile among the plurality of candidate video profiles;
Determining an added transcoding profile combination from at least one prepared transcoding profile combination;
Determining the service metric incremental information according to the target metric information of the target profile combination and the added transcoding metric information of the added transcoding profile combination;
Determining, according to the service metric incremental information, to combine the added transcoding profile combination or the target profile combination as the final profile combination corresponding to the video transcoding command of the target video.

According to one or more embodiments of the present disclosure, [Example 13] provides the method of [Example 12], the target metric information of the target profile combination is represented by the target metric function value, and the rotation metric information of the addition profile combination is represented by the added transcoding metric function value, and determining the service metric incremental information according to the target metric information of the target profile combination and the addition metric information of the addition profile combination may include:
Taking the difference between the target metric function value and the added transcoding metric function value as the service metric incremental information;
The determining, according to the incremental information of the service metric, the combined profile combination or the target profile combination as the final profile combination corresponding to the video transcoding command of the target video includes:

If the incremental information of the service metric is greater than the preset increment threshold, combining the target profile combination as the final profile combination corresponding to the video transcoding command of the target video;
If the service metric incremental information is not greater than the preset increment threshold, the added transcoding profile combination is used as the final profile combination.

According to one or more embodiments of the present disclosure, there is provided an apparatus of video resource management [Example 14], which may include:
A candidate profile combination obtaining module, configured to determine service metric information of each candidate video profile of the target video, and obtain at least one candidate profile combination, where the candidate profile combination may include at least one candidate video profile;
A target metric information determination module, configured to, for each candidate profile combination, determine target metric information of the candidate profile combination according to the service metric information of each candidate video profile in the candidate profile combination;
The target profile combination determination module is configured to determine the target profile combination of the target video from the at least one candidate profile combination according to the target metric information of each candidate profile combination.

Further, while multiple operations are depicted in a particular order, this should not be understood to require that these operations be performed in the particular order shown or in sequential order. In certain circumstances, multitasking and parallel processing may be advantageous. Likewise, while multiple implementation details are included in the discussion above, these should not be construed as limiting the scope of the present disclosure. Some features described in the context of separate embodiments may also be implemented in combination in a single embodiment. Conversely, the various features described in the context of a single embodiment may also be implemented in multiple embodiments either individually or in any suitable sub-combination.

1-17. (canceled)

18. A method of video resource management, comprising:
determining service metric information of each candidate video profile of a target video, to obtain at least one candidate profile combination, wherein a candidate profile combination comprises at least one candidate video profile;
for each candidate profile combination, determining target metric information of a candidate profile combination according to service metric information of each candidate video profile within a candidate profile combination;
determining a target profile combination of a target video from at least one candidate profile combination according to target metric information of each candidate profile combination.

19. The method of claim 18, wherein the determining the service metric information of each candidate video profile of the target video comprises:
obtaining a service metric function and profile attribute information of each candidate video profile of the target video, where the service metric function is constructed based on a profile attribute of the candidate video profile, and the profile attribute information is information of the candidate video profile on the profile attribute;
for each candidate video profile, obtaining a service metric function value according to the service metric function and the profile attribute information of the candidate video profile, to use the service metric function value as the service metric information of the candidate video profile;
the determining a target profile combination of a target video from at least one candidate profile combination according to target metric information of each candidate profile combination includes:
selecting, as the target profile combination of the target video, a candidate profile combination corresponding to the target metric information with the largest numerical value in the target metric information of the at least one candidate profile combination.

20. The method of claim 19, wherein the profile attributes include at least one of video code rate, video quality, transcoding overhead, and resolution.

21. The method of claim 18, further comprising:
determining a playing probability of each candidate video profile;
the determining a target profile combination of a target video from at least one candidate profile combination according to target metric information of each candidate profile combination includes:
determining target metric information of the candidate profile combination according to the service metric information and the playing probability of each candidate video profile in the candidate profile combination.

22. The method of claim 21, wherein the determining target metric information of the candidate profile combination according to the service metric information and the playing probability of each candidate video profile in the candidate profile combination comprises:
determine each candidate video profile in the candidate profile combination as a playing video profile;
for each playing video profile, obtaining playing metric information of the playing video profile according to the service metric information and the playing probability of the playing video profile;
obtaining target metric information of the candidate profile combination according to the playing metric information of each playing video profile.

23. The method of claim 21, wherein the determining a playing probability of each candidate video profile comprises:
obtaining a playing probability density function, wherein the playing probability distribution corresponding to the playing probability density function is obtained by a fitting operation according to historical information of a video platform at which the target video is located;
determining, for each candidate video profile, a playing probability of the candidate video profile based on the playing probability density function.

24. The method of claim 23, wherein the historical information comprises at least one of user internet speed information, client playing profile information, and server issuing profile information.

25. The method of claim 24, wherein the historical information is the user internet speed information, the playing probability distribution is obtained by a fitting operation by:
determining a user internet speed distribution corresponding to the user internet speed information;
for each network bandwidth under the user internet speed distribution, determining a maximum code rate corresponding to the network bandwidth and a historical video profile corresponding to the maximum code rate; and
obtaining the playing probability distribution by a fitting operation according to the user internet speed distribution and the historical video profile corresponding to each network bandwidth.

26. The method of claim 18, wherein the determining the service metric information of each candidate video profile of the target video comprises:
in accordance with a determination of a video transcoding command, determining a transcoding constraint condition of the target video to be transcoded and service metric information of each candidate video profile of the target video;
the determining target metric information of the candidate profile combination according to the service metric information of each candidate video profile in the candidate profile combination includes:
determining target metric information of the candidate profile combination according to the service metric information of each candidate video profile in the candidate profile combination and the transcoding constraint condition.

27. The method of claim 26, wherein the determining the target metric information of the candidate profile combination according to the service metric information of each candidate video profile in the candidate profile combination and the transcoding constraint condition comprises:
in accordance with a determination that the candidate profile combination meets the transcoding constraint condition, determining target metric information of the candidate profile combination according to the service metric information of each candidate video profile in the candidate profile combination.

28. The method of claim 26, wherein the transcoding constraint comprises at least one of the following conditions:
a video code rate of each candidate video profile in the candidate profile combination is less than or equal to a preset maximum code rate and/or is greater than or equal to a preset minimum code rate;
the number of profiles of the candidate video profiles in the candidate profile combination is less than or equal to a preset maximum number and/or is greater than or equal to a preset minimum number;
a difference between the video code rates of every two candidate video profiles in the candidate profile combination is less than or equal to a preset maximum code rate difference.

29. The method of claim 18, further comprising:
in accordance with a determination that a video transcoding command is received and the target video to be transcoded corresponds to a transcoded video profile, obtaining at least one prepared transcoding profile combination, wherein the prepared transcoding profile combination includes the transcoded video profile and at least one prepared transcoding video profile, and the prepared transcoding video profile is a candidate video profile other than the transcoded video profile among a plurality of candidate video profiles;
determining an added transcoding profile combination from the at least one prepared transcoding profile combination;
determining service metric incremental information according to the target metric information of the target profile combination and the added transcoding metric information of the added transcoding profile combination;
determining, according to service metric incremental information, an added transcoding profile combination or a target profile combination as a final profile combination corresponding to a video transcoding command of a target video.

30. The method of claim 29, wherein the target metric information of the target profile combination is represented by a target metric function value, and the added transcoding metric information of the added transcoding profile combination is represented by an added transcoding metric function value, and the determining the service metric incremental information according to the target metric information of the target profile combination and the added transcoding metric information of the added transcoding profile combination comprises:
determine a difference between the target metric function value and the added transcoding metric function value as the service metric incremental information;
the determining, according to the service metric incremental information, the added transcoding profile combination or the target profile combination as a final profile combination corresponding to the video transcoding command of the target video includes:
in accordance with a determination that the service metric incremental information is greater than a preset increment threshold, using the target profile combination as a final profile combination corresponding to the video transcoding command of the target video;
in accordance with a determination that the service metric incremental information is not greater than a preset increment threshold, combining the added transcoding profile combination as the final profile combination.

31. An electronic device, comprising:
at least one processor;
a memory configured to store at least one program;
the at least one program, when executed by the at least one processor, cause the at least one processor to perform a method comprising:
determining service metric information of each candidate video profile of a target video, to obtain at least one candidate profile combination, wherein a candidate profile combination comprises at least one candidate video profile;
for each candidate profile combination, determining target metric information of a candidate profile combination according to service metric information of each candidate video profile within a candidate profile combination;
determining a target profile combination of a target video from at least one candidate profile combination according to target metric information of each candidate profile combination.

32. The device of claim 31, wherein the determining the service metric information of each candidate video profile of the target video comprises:
obtaining a service metric function and profile attribute information of each candidate video profile of the target video, where the service metric function is constructed based on a profile attribute of the candidate video profile, and the profile attribute information is information of the candidate video profile on the profile attribute;
for each candidate video profile, obtaining a service metric function value according to the service metric function and the profile attribute information of the candidate video profile, to use the service metric function value as the service metric information of the candidate video profile;
the determining a target profile combination of a target video from at least one candidate profile combination according to target metric information of each candidate profile combination includes:
selecting, as the target profile combination of the target video, a candidate profile combination corresponding to the target metric information with the largest numerical value in the target metric information of the at least one candidate profile combination.

33. The device of claim 31, the method further comprising:
determining a playing probability of each candidate video profile;
the determining a target profile combination of a target video from at least one candidate profile combination according to target metric information of each candidate profile combination includes:
determining target metric information of the candidate profile combination according to the service metric information and the playing probability of each candidate video profile in the candidate profile combination.

34. The device of claim 33, wherein the determining target metric information of the candidate profile combination according to the service metric information and the playing probability of each candidate video profile in the candidate profile combination comprises:
determine each candidate video profile in the candidate profile combination as a playing video profile;
for each playing video profile, obtaining playing metric information of the playing video profile according to the service metric information and the playing probability of the playing video profile;
obtaining target metric information of the candidate profile combination according to the playing metric information of each playing video profile.

35. The device of claim 31, wherein the determining the service metric information of each candidate video profile of the target video comprises:
in accordance with a determination of a video transcoding command, determining a transcoding constraint condition of the target video to be transcoded and service metric information of each candidate video profile of the target video;
the determining target metric information of the candidate profile combination according to the service metric information of each candidate video profile in the candidate profile combination includes:
determining target metric information of the candidate profile combination according to the service metric information of each candidate video profile in the candidate profile combination and the transcoding constraint condition.

36. The device of claim 31, further comprising:
in accordance with a determination that a video transcoding command is received and the target video to be transcoded corresponds to a transcoded video profile, obtaining at least one prepared transcoding profile combination, wherein the prepared transcoding profile combination includes the transcoded video profile and at least one prepared transcoding video profile, and the prepared transcoding video profile is a candidate video profile other than the transcoded video profile among a plurality of candidate video profiles;
determining an added transcoding profile combination from the at least one prepared transcoding profile combination;
determining service metric incremental information according to the target metric information of the target profile combination and the added transcoding metric information of the added transcoding profile combination;
determining, according to service metric incremental information, an added transcoding profile combination or a target profile combination as a final profile combination corresponding to a video transcoding command of a target video.

37. A computer-readable storage medium storing a computer program, wherein the computer program, when executed by a processor,
a method comprising:
determining service metric information of each candidate video profile of a target video, to obtain at least one candidate profile combination, wherein a candidate profile combination comprises at least one candidate video profile;
for each candidate profile combination, determining target metric information of a candidate profile combination according to service metric information of each candidate video profile within a candidate profile combination;
determining a target profile combination of a target video from at least one candidate profile combination according to target metric information of each candidate profile combination.
